(19) United States
(12) Patent Application Publication
(10) Pub. No.: US 2018/0267714 A1
(43) Pub. Date: Sep. 20, 2018

(54) MANAGING DATA IN A STORAGE ARRAY

(71) Applicant: HEWLETT PACKARD ENTERPRISE DEVELOPMENT LP, Houston, TX (US)

(72) Inventors: Siamak Nazari, Fremont, CA (US); William Joshua Price, Fremont, CA (US); Anahita Afkham, Fremont, CA (US); Danyaal Masood Khan, Fremont, CA (US)

(21) Appl. No.: 15/761,950

(22) PCT Filed: Jan. 22, 2016
(86) PCT No.: PCT/US2016/014456

§ 371 Date: Mar. 21, 2018

(51) Int. Cl. G06F 3/06

(52) U.S. Cl. CPC G06F 3/0608; G06F 3/0647; G06F 3/0673; G06F 3/0659; G06F 3/0653

(57) ABSTRACT

Techniques are described herein for managing data in a storage array. A system includes a distributing unit to distribute compressible data and uncompressible data across compression-capable drives. The system also includes a vacating unit to vacate an excess chunklet to another drive in the storage array if a new compression factor is less than a default compression factor for the storage array.

### BACKGROUND

Data compression involves encoding information using fewer bits than the original representation. Data compression is useful because it reduces resource usage, such as data storage space.

### DESCRIPTION OF THE DRAWINGS

Certain exemplary embodiments are described in the following detailed description and in reference to the drawings, in which:

FIG. 1 is an example of an unbalanced storage array;

FIG. 2 is an example of a balanced storage array;

FIG. 3 is an example of a system for managing data in a storage array;

FIG. 4 is a process flow diagram of an example method for managing data in a storage array; and

FIG. 5 is a block diagram of an example memory storing non-transitory, machine readable instructions comprising code to direct one or more processing resources to manage data in a storage array.

### DETAILED DESCRIPTION

The capacity of a drive in a storage array is unpredictable because it is a function of the compressibility of the data being written to the drive. Present techniques provide for the management of the capacity of compression-capable drives without taking into account the variability introduced by compression. These techniques may be inefficient in that they result in less-than-optimal utilization of memory resources.

On a drive without compression capability, there is typically a one-to-one relationship between the raw capacity of the drive and the amount of data that can be written to the drive. Real-time data compression changes this relationship based on the type of data being written to the drive. For example, with highly compressible data, many times the raw capacity of the drive can be stored on a drive having compression capability. With truly random data, the amount of data stored may be less than the capacity of the drive. Accordingly, considerable inconsistency in storage capacity can occur when different types of data are written to a compression-capable drive.

Techniques are provided herein for managing the capacity of compression-capable drives by taking into consideration the variability introduced by compression. These techniques may result in better utilization of memory resources.

In some examples, each drive in a storage array will have its own compression capability. Each drive has a compression factor assigned to it based on testing. For example, a 1 terabyte (TB) drive capable of storing 4 TB has a compression factor of four. The compression factors for the individual drives are used to calculate a default compression factor for the storage array.

When data in the storage array is changed, the data on the drives may become unbalanced. In an unbalanced array, the drives have differing amounts of uncompressible data, low compression ratio data, and high compression ratio data stored on them. In contrast, in a balanced system, data is written evenly across the drives in the storage array. For example, the drives have the same amounts of uncompressible data, low compression ratio data, and high compression ratio data stored on them.

To return balance after a change is made to the array, compressible and uncompressible data are evenly distributed across the drives if only compression-capable drives are available. Uncompressible data may be moved to compression-incapable drives if compression-incapable drives are present in the array.

A new compression factor is calculated for the array and compared to the default compression factor. If the new compression factor is less than the default compression factor, excess chunklets are vacated to reflect the new smaller capacity. A chunklet is a logically contiguous address range on non-volatile media of a fixed size. An excess chunklet has data written to it but cannot accept any more data because there is inadequate storage space for all the data. Any data that is written to the chunklet is moved to other drives in the array, i.e., the chunklet is vacated. If the new compression factor is greater than or equal to the default compression factor, there are no excess chunklets to be vacated.

The process repeats itself every time a change is made to the data in the storage array. Returning the array to the balanced state better utilizes storage resources from the standpoint of both an individual drive and the entire array.

Rebalancing of a storage array is necessary if additional drives are added and the additional drives have different compression ratios than the existing drives in the array. If the compression ratios are higher, storing compressible data on the new drives is preferable to storing compressible data on the existing drives. If the new drives have a greater amount of unused space, storing of any type of data on the new drives is preferable to storing data on the existing drives. As to the actual rebalancing of the data in the array, the different compression ratios are taken into consideration. Drives with higher compression ratios receive more compressible data than drives with lower compression ratios, all other factors being equal.

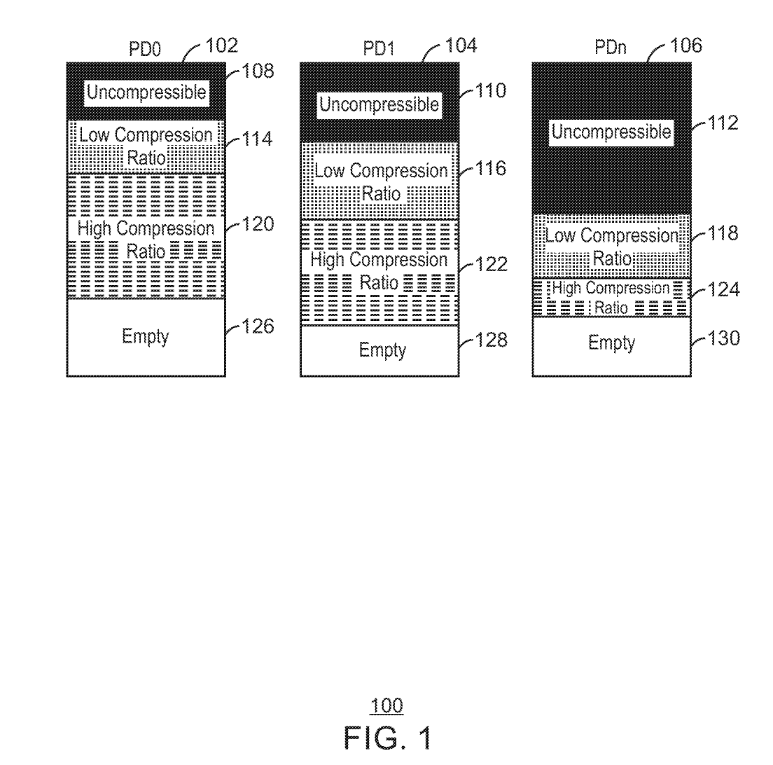

FIG. 1 is an example of an unbalanced storage array 100. The array 100 is made up of physical drives PD0 102, PD1 104, PDn 106. The physical drives 102, 104, 106 are all compression-capable drives. Because of the variability in data compression, the physical drives 102, 104, 106 are unbalanced. In other words, the amount of uncompressible data 108 on PD0 102 differs from the amount of uncompressible data 110 on PD1 104 and the amount of uncompressible data 112 on PDn 106. Likewise, the amount of low compression ratio data 114 on PD0 102 differs from the amount of low compression ratio data 116 on PD1 104 and the amount of low compression ratio data 118 on PDn 106. The amount of high compression ratio data 120 on PD0 102 differs from the amount of high compression ratio data 122 on PD1 104 and the amount of high compression ratio data 124 on PDn 106. The amount of empty space 126 on PD0 102 differs from the amount of empty space 128 on PD1 104 and the amount of empty space 130 on PDn 106. The storage array 100 would be unbalanced as shown in FIG. 1 after a change is made to the array 100.

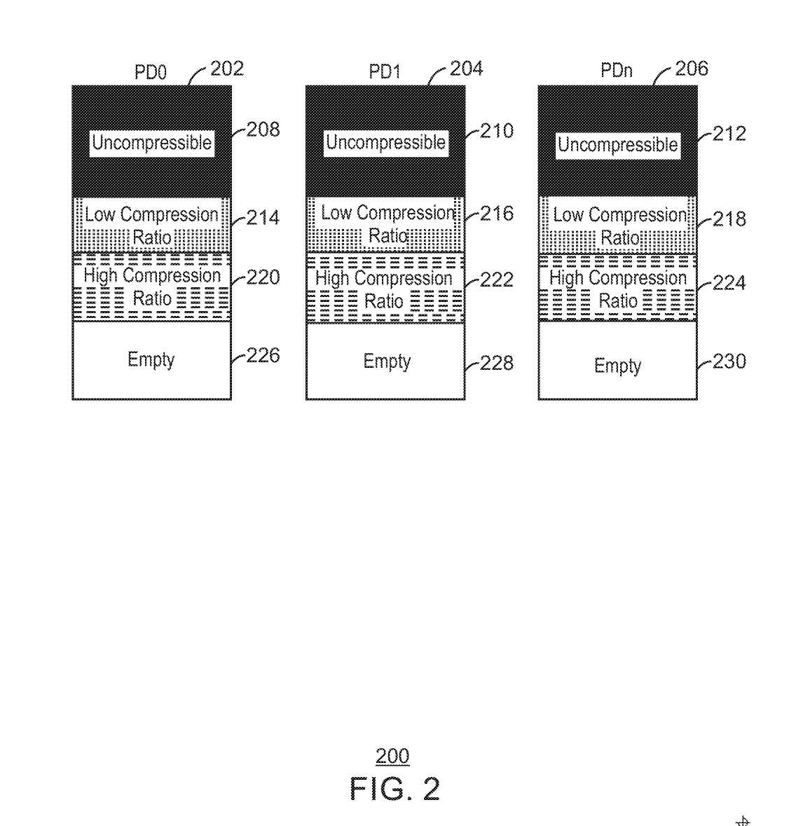

FIG. 2 is an example of a balanced storage array 200. For example, the unbalanced storage array 100 in FIG. 1 would look like the balanced storage array 200 after performance of the techniques described herein. The array 200 is made up of physical drives PD0 202, PD1 204, PDn 206. The physical drives 202, 204, 206 are all compression-capable drives. Because the array is balanced, the amount of uncompressible data 208 on PD0 202 is the same as the amount of uncompressible data 210 on PD1 204 and the amount of uncompressible data 212 on PDn 206. Likewise, the amount of low compression ratio data 214 on PD0 202 is the same as the amount of low compression ratio data 216 on PD1 204 and the amount of low compression ratio data 218 on PDn 206. The amount of high compression ratio data 220 on PD0 202 is the same as the amount of high compression ratio data 222 on PD1 204 and the amount of high compression ratio data 224 on PDn 206. The amount of empty space 226 on PD0 202 is the same as the amount of empty space 228 on PD1 204 and the amount of empty space 230 on PDn 206.

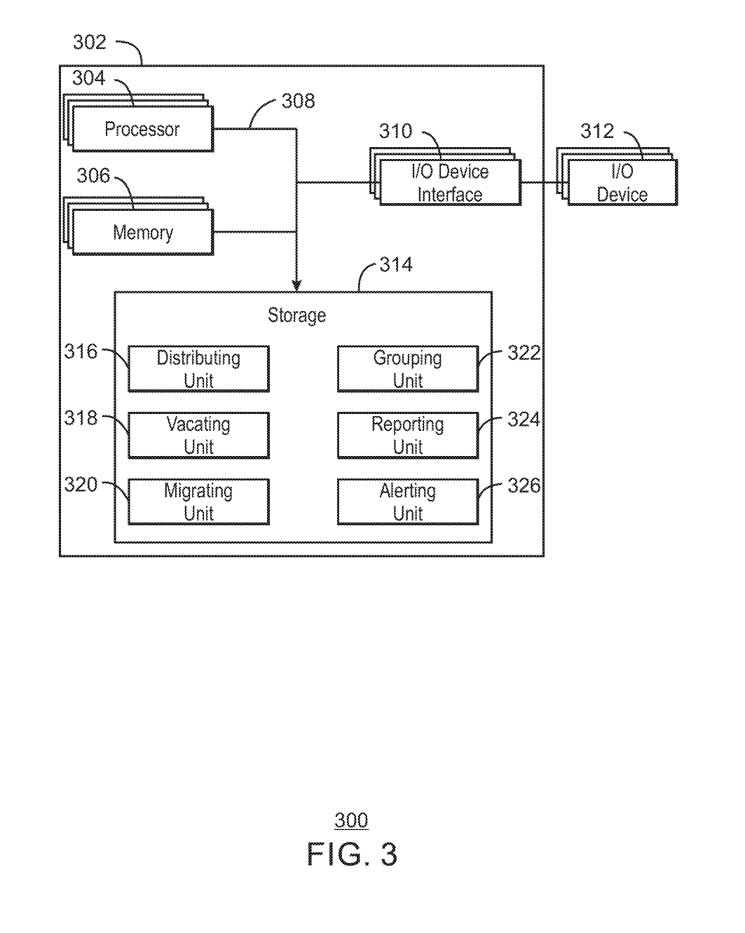

FIG. 3 is an example of a system 300 for managing data in a storage array. In this example, a computing device 302 may perform the functions described herein. The computing device 302 may include a processor 304 that executes stored instructions, as well as a memory 306 that stores the instructions that are executable by the processor 304. The computing device 302 may be any electronic device capable of data processing such as a server and the like. The processor 304 can be a single core processor, a dual-core processor, a multi-core processor, a number of processors, a computing cluster, a cloud sever, or the like. The processor 304 may be coupled to the memory 306 by a bus 308 where the bus 308 may be a communication system that transfers data between various components of the computing device 302. In examples, the bus 308 may include a Peripheral Component Interconnect (PCI) bus, an Industry Standard Architecture (ISA) bus, a PCI Express (PCIe) bus, high performance links, such as the Intel® Direct Media Interface (DMI) system, and the like.

The memory 306 can include random access memory (RAM), e.g., static RAM (SRAM), dynamic RAM (DRAM), zero capacitor RAM, embedded DRAM (eDRAM), extended data out RAM (EDO RAM), double data rate RAM (DDR RAM), resistive RAM (RRAM), and parameter RAM (PRAM); read only memory (ROM), e.g., mask ROM, programmable ROM (PROM), erasable programmable ROM (EPROM), and electrically erasable programmable ROM (EEPROM); flash memory; or any other suitable memory systems.

The computing device 302 may also include an input/output (I/O) device interface 310 configured to connect the computing device 302 to one or more I/O devices 312. For example, the I/O devices 312 may include a printer, a scanner, a keyboard, and a pointing device such as a mouse, touchpad, or touchscreen, among others. The I/O devices 312 may be built-in components of the computing device 302, or may be devices that are externally connected to the computing device 302.

The computing device 302 may also include a storage device 314. The storage device 314 may include non-volatile storage devices, such as a solid-state drive, a hard drive, a tape drive, an optical drive, a flash drive, an array of drives, or any combinations thereof. In some examples, the storage device 314 may include non-volatile memory, such as non-volatile RAM (NVRAM), battery backed up DRAM, and the like. In some examples, the memory 306 and the storage device 314 may be a single unit, e.g., with a contiguous address space accessible by the processor 304.

The storage device 314 may include a number of units to provide the computing device 302 with the capability to manage data in a storage array. The units may be software modules, hardware encoded circuitry, or a combination thereof. For example, a distributing unit 316 may evenly distribute compressible and uncompressible data across the drives in a storage array if only compression-capable drives are available.

A new compression factor may be calculated after the data is divided among the drives by the distributing unit 316. A vacating unit 318 may vacate an excess chunklet to another drive in the array if the new compression factor is less than the default compression factor calculated from the compression factors assigned to the individual drives after testing. An excess chunklet may have data written to it but cannot accept any more data because there is inadequate storage space for all the data. Any data that is written to the chunklet may be moved to another drive in the array by the vacating unit 318.

A migrating unit 320 may migrate uncompressible data to a compression-incapable drive if such a drive is available. If a compression-incapable drive is available, all of the uncompressible data may be stored on the compression-incapable drive. The compressible data may be evenly allotted only to compression-capable drives by the distributing unit 316. The distributing unit 316 may not distribute uncompressible data to a compression-capable drive if a compression-incapable drive is present in the storage array.

A grouping unit 322 may group data on a drive according to the data's compressibility. For example, if an array is composed of only compression-capable drives, all the uncompressible data may be grouped together on each individual drive. The same may be said of low compression ratio data and high compression ratio data. The result is an array that looks like the array 200 in FIG. 2. If an array contains compression-incapable drives, uncompressible data may be stored on the compression-incapable drives and not on the compression-capable drives.

A reporting unit 324 may report a characteristic of a drive to the storage array. For example, as data is written to a drive, the reporting unit 324 may inform the array of the number of write bytes received and host bytes written. The number of host bytes written that is reported to the array may not include any writes written as a function of the drive's internal characteristics and mechanisms such as garbage collection and write amplification.

In addition to the number of write bytes received and host bytes written, the reporting unit 324 may also report the utilized physical capacity of a drive to the array. This information may be reported as the number of used and free blocks. The reporting unit 324 may make information about a drive accessible to the array using a log page or other suitable mechanism.

An alerting unit 326 may alert the storage array when a threshold capacity limit of a drive has been reached. These limits may be non-linear and increase in occurrence as the amount of data written to the drive nears the capacity of the drive. For example, the alerting unit 326 may alert the storage array when the amount of data on the drive is at 50%, 75%, 85%, 90%, 95%, and 100% of the drive's capacity. The alerting unit 326 may alert the storage array using a retrievable sense code, a command completion code, or the like.

The block diagram of FIG. 3 is not intended to indicate that the system 300 for managing data in a storage array is to include all the components shown. For example, the migrating unit 320 may not be used in some implementations where only compression-capable drives are present in the storage array. Further, any number of additional units may be included within the system 300 for managing data in a storage array depending on the details of the specific implementation. For example, a calculating unit may be added to the system 300 to calculate the array's default compression factor from the compression factors for the individual drives.

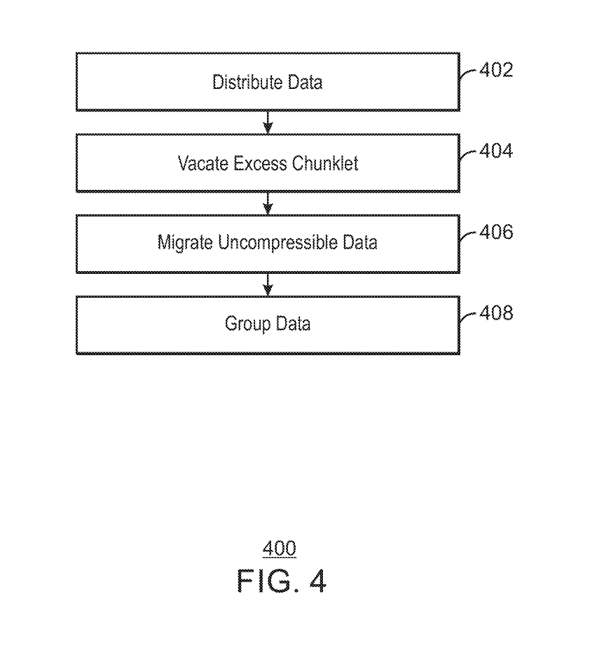

FIG. 4 is a process flow diagram of an example method 400 for managing data in a storage array. The method 400 may be performed by the system 300 described with respect to FIG. 3. In this example, the method 400 takes an unbalanced array such as that in FIG. 1 and converts it to a balanced array such as that in FIG. 2.

The method 400 begins at block 402 with the even distribution of compressible and uncompressible data across the drives in a storage array and the calculation of a new compression factor for the array. At block 404, an excess chunklet is vacated if the new compression factor is less than the default compression factor for the array. At block 406, uncompressible data is migrated to a compression-incapable drive if a compression-incapable drive is present in the storage array. At block 408, data is grouped on a drive according to the data's compressibility. The method 400 may repeat itself every time data in the array is changed.

The process flow diagram of FIG. 4 is not intended to indicate that the method 400 for the management of data in a storage array is to include all the blocks shown. For example, block 406 may not be used in some implementations where only compression-capable drives are present in the storage array. Further, any number of additional blocks may be included within the method 400 depending on the details of the specific implementation. For example, a block may be added for the calculation of the array's default compression factor from the compression factors for the individual drives.

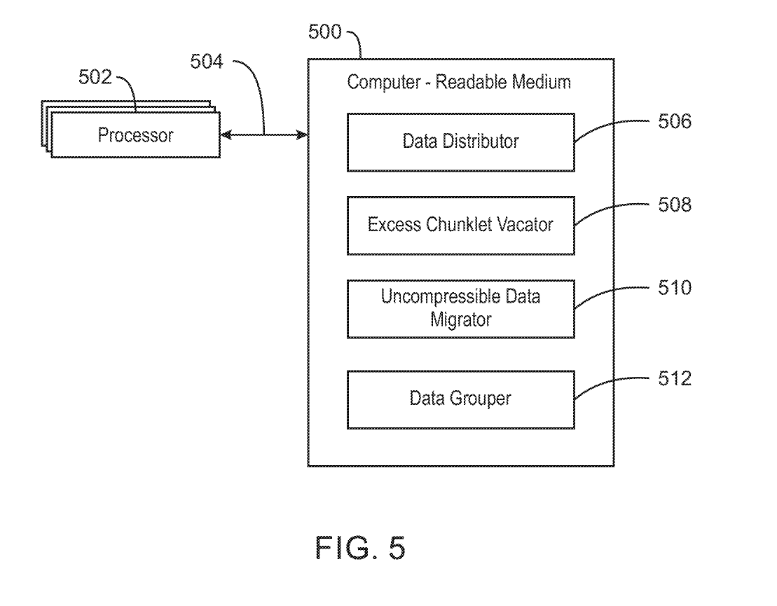

FIG. 5 is a block diagram of an example memory 500 storing non-transitory, machine readable instructions comprising code to direct one or more processing resources to manage data in a storage array. The memory 500 is coupled to one or more processors 502 over a bus 504. The processor 502 and bus 504 may be as described with respect to the processor 304 and bus 308 of FIG. 3.

The memory 500 includes a data distributor 506 to direct one of the one or more processors 502 to distribute compressible and uncompressible data across compressible-capable drives in a storage array and to calculate a new compression factor for the array. Excess chunklet vacator 508 directs one of the one or more processors 502 to vacate data from an excess chunklet to other drives in the array if the new compression factor is less than the default compression factor for the array. The memory 500 also includes an uncompressible data migrator 510 to direct one of the one or more processors 502 to migrate uncompressible data to compression-incapable drives if compression-incapable drives are present in the array. Data grouper 512 may direct one of the one or more processors 502 to group data on drives according to the compressibility of the data.

The code blocks described above do not have to be separated as shown; the code may be recombined into different blocks that perform the same functions. Further, the machine readable medium does not have to include all of the blocks shown in FIG. 5. However, additional blocks may be added. The inclusion or exclusion of specific blocks is dictated by the details of the specific implementation.

While the present techniques may be susceptible to various modifications and alternative forms, the exemplary examples discussed above have been shown only by way of example. It is to be understood that the techniques are not intended to be limited to the particular examples disclosed herein. Indeed, the present techniques include all alternatives, modifications, and equivalents falling within the scope of the present techniques.

What is claimed is:

1. A system for managing data in a storage array, comprising:
a distributing unit to distribute compressible data and uncompressible data across compression-capable drives; and
a vacating unit to vacate an excess chunklet to another drive in the storage array if a new compression factor is less than a default compression factor for the storage array.

2. The system of claim 1, further comprising a migrating unit to migrate uncompressible data to a compression-incapable drive.

3. The system of claim 1, further comprising a grouping unit to group data on a drive according to its compressibility.

4. The system of claim 1, further comprising a reporting unit to report a characteristic of a drive in a storage array to the storage array.

5. The system of claim 4, wherein the reporting unit uses a log page to report the characteristic of the drive to the storage array.

6. The system of claim 4, wherein the characteristic of the drive comprises the number of write bytes received, the number of host bytes written, the number of used blocks, and the number of free blocks.

7. The system of claim 1, further comprising an alerting unit to alert the storage array when a threshold capacity limit of the drive has been reached.

8. The system of claim 7, wherein the alerting unit uses a retrievable sense code to alert the storage array.

9. The system of claim 7, wherein the alerting unit uses a command completion code to alert the storage array.

10. A method for managing data in a storage array, comprising:
distributing compressible data and uncompressible data across compression-capable drives; and
vacating an excess chunklet to another drive in the storage array if a new compression factor is less than a default compression factor for the storage array.

11. The method of claim 10, further comprising migrating uncompressible data to compression-incapable drives.

12. The system of claim 10, further comprising grouping data on a drive according to its compressibility.

13. A non-transitory, computer readable medium comprising machine-readable instructions for managing data in a storage array, the instructions, when executed, direct a processor to:
distribute compressible data and uncompressible data across compression-capable drives; and
vacate an excess chunklet to another drive in the storage array if a new compression factor is less than a default compression factor for the storage array.

14. The non-transitory, computer readable medium comprising machine-readable instructions of claim 13, further comprising code to direct the processor to migrate uncompressible data to compression-incapable drives.

15. The non-transitory, computer readable medium comprising machine-readable instructions of claim 13, further comprising code to direct the processor to group data on a drive according to its compressibility.
